(19) United States
(12) Patent Application Publication
(10) Pub. No.: US 2026/0253204 A1
(43) Pub. Date: Aug. 27, 2026

(54) INFORMATION PROCESSING APPARATUS AND INFORMATION PROCESSING METHOD

(71) Applicant: Sony Semiconductor Solutions Corporation, Kanagawa (JP)

(72) Inventor: Serge HUSTIN, Brussels (BE)

(73) Assignee: Sony Semiconductor Solutions Corporation, Kanagawa (JP)

(21) Appl. No.: 19/161,335

(22) PCT Filed: Feb. 22, 2024
(86) PCT No.: PCT/EP2024/054474

§ 371 Date: Sep. 2, 2025

(30) Foreign Application Priority Data
Mar. 10, 2023 (EP) 23161272.2

(51) Int. Cl. G06T 7/00; G06T 11/00

(52) U.S. Cl. CPC G06T 7/001; G06T 11/00; G06T 2207/20084

(57) ABSTRACT

The disclosure pertains to an information processing apparatus that includes circuitry configured to: obtain image data captured with a camera; determine a degree of image degradation based on the obtained image data, wherein the degree of image degradation indicates a degree of a physical reduction of an imaging capability of the camera; and determine, based on the determined degree of image degradation, an operation mode of the information processing apparatus.

### TECHNICAL FIELD

The present disclosure generally pertains to an information processing apparatus and an information processing method.

### TECHNICAL BACKGROUND

It is generally known to operate an information processing apparatus based on an image captured with a camera. For example, an operation of a robot may be controlled based on an image of an operation area in which the robot operates. For example, a motion of a vehicle may be controlled based on an image of a route ahead of the vehicle.

Although there exist techniques for operating an information processing apparatus based on an image captured with a camera, it is generally desirable to provide an improved information processing apparatus and information processing method.

### SUMMARY

According to a first aspect, the disclosure provides an information processing apparatus, comprising circuitry configured to: obtain image data captured with a camera; determine a degree of image degradation based on the obtained image data, wherein the degree of image degradation indicates a degree of a physical reduction of an imaging capability of the camera; and determine, based on the determined degree of image degradation, an operation mode of the information processing apparatus.

According to a second aspect, the disclosure provides an information processing method, comprising: obtaining image data captured with a camera; determining a degree of image degradation based on the obtained image data, wherein the degree of image degradation indicates a degree of a physical reduction of an imaging capability of the camera; and determining, based on the determined degree of image degradation, an operation mode of an information processing apparatus.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates an information processing apparatus according to an embodiment;

FIG. 2 illustrates an information processing method according to an embodiment;

FIG. 3 illustrates a method of determining an ability of an image degradation monitor to detect an image degradation according to an embodiment;

FIG. 4 illustrates an embodiment of a general-purpose computer;

FIG. 5 is a block diagram depicting an example of schematic configuration of a vehicle control system; and

FIG. 6 is a diagram of assistance in explaining an example of installation positions of an outside-vehicle information detecting section and an imaging section.

### DETAILED DESCRIPTION OF EMBODIMENTS

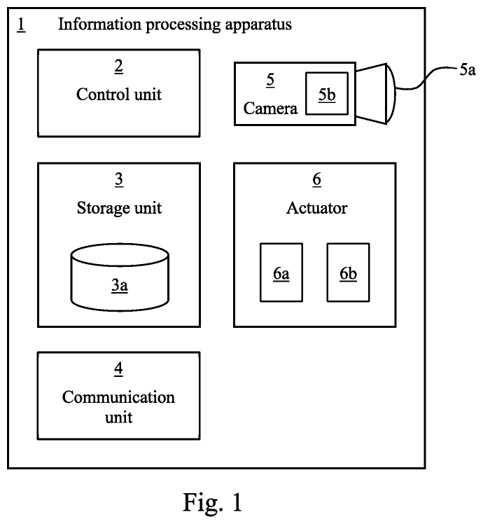

Before a detailed description of the embodiments under reference of FIG. 1 is given, general explanations are made.

As mentioned in the outset, it is generally known to operate an information processing apparatus based on an image captured with a camera.

For example, an operation of a robot may be controlled based on an image of an operation area in which the robot operates. Based on the image of the operation area, the robot may detect an operation object in the operation area and may pick up the operation object and/or work on the operation object. Based on the image of the operation area, the robot may also detect an obstacle in the operation area for avoiding a collision with the obstacle and/or may detect a person in the operation area for avoiding an injury of the person.

For example, a motion of a vehicle may be controlled based on an image of a route ahead of the vehicle. Based on the image of the route ahead, the vehicle may detect a course of the route (e.g., a curve) and follow the detected course and/or may detect a road sign (e.g., stop sign or speed limit) and control the motion of the vehicle according to the detected road sign. Based on the image of the route ahead, the vehicle may also detect an obstacle on the route ahead for avoiding a collision with the obstacle and/or may detect a person on the route ahead for avoiding an injury of the person.

However, if an imaging capability of the camera is physically reduced, e.g., due to a low contrast, due to smoke and/or due to a pixel failure, an image captured with the camera may be subject to image degradation such that a performance of the information processing apparatus may be reduced if the information processing apparatus is operated based on the image subject to image degradation.

For example, a robot controlled based on a degraded image of the operation area may not detect an operation object and may not be able to pick up and/or work on the operation object. A robot controlled based on a degraded image of the operation area may also not detect an obstacle and/or a person in the operation area and, thus, may not be able to avoid a collision with the obstacle and/or an injury of the person.

For example, a vehicle controlled based on a degrade image of the route ahead may not detect a course of the route and/or a road sign and may not be able to follow the course of the route ahead and/or to control the motion of the vehicle according to the road sign. A vehicle controlled based on a degraded image of the road ahead may also not detect an obstacle and/or a person on the route ahead and, thus, may not be able to avoid a collision with the obstacle and/or an injury of the person.

Therefore, the information processing apparatus and/or the camera may be provided with a diagnostics function that may detect when an image quality of images imaged by the camera is so degraded that the information processing apparatus should not rely upon the camera.

This may be particularly important in a safety environment in which cameras may be required to be able to self-diagnose and go in a safe mode when a situation that could lead to failure and/or to danger occurs, e.g., if an undetected condensation on a lens of a camera leads to a cloudy image that could cause a robot/worker proximity image processing application to fail to detect a dangerous proximity or that could cause a vehicle control application to fail to detect a person in front of a moving vehicle.

In consideration of the above, the present disclosure pertains to an information processing apparatus that includes circuitry configured to: obtain image data captured with a camera; determine a degree of image degradation based on the obtained image data, wherein the degree of image degradation indicates a degree of a physical reduction of an imaging capability of the camera; and determine, based on the determined degree of image degradation, an operation mode of the information processing apparatus.

The information processing apparatus may include any apparatus that operates based on image data captured with a camera. For example, the information processing apparatus may include a robot, a vehicle, a drone, a surveillance system or the like.

For example, the information processing apparatus may be a robot that operates (e.g., picks up and/or works on) an operation object based on the image data captured by the camera. The robot may operate in proximity to a human worker and/or may operate in an operation area that may be crossed by a human worker, and the robot may detect the human worker based on the image data captured by the camera for avoiding a collision with and/or an injury of the human worker.

For example, the information processing apparatus may be a vehicle, e.g., an autonomously driving vehicle and/or a vehicle with a driver assistance system. A control unit of the vehicle may control a motion (e.g., speed, direction, acceleration and/or retardation) or the like of the vehicle based on the image data captured by the camera. The vehicle may detect a course of a route, a traffic sign, an obstacle and/or a person on a route ahead based on the image data captured by the camera and may control the motion of the vehicle according to the course of the route and/or according to the traffic sign and/or may control the motion of the vehicle to avoid a collision with the obstacle and/or person.

For example, the information processing apparatus may be a drone (an unmanned aerial vehicle (UAV), e.g., a quadcopter, any other multicopter, a helicopter, an airplane or the like), e.g., an autonomously flying drone. A control unit of the drone may detect a flight route, a destination and/or an obstacle based on the image data captured by the camera. The control unit may control the drone to follow the flight route, to fly towards (and, e.g., land at) the destination and/or to avoid the obstacle.

For example, the information processing apparatus may be a surveillance system that surveils a (e.g., predefined) region based on the image data captured by the camera. Based on the image data captured by the camera, the surveillance system may monitor the range to stop an operation of a machine/robot in the range when it is detected that a person has entered the region for avoiding an injury of the person. Based on the image data captured by the camera, the surveillance system may monitor an operation of a machine/robot, e.g., a production process for monitoring a quality of a product manufactured in the production process. Based on the image data captured by the camera, the surveillance system may observe the region for detecting an unauthorized intrusion and/or may record the image data for later reference.

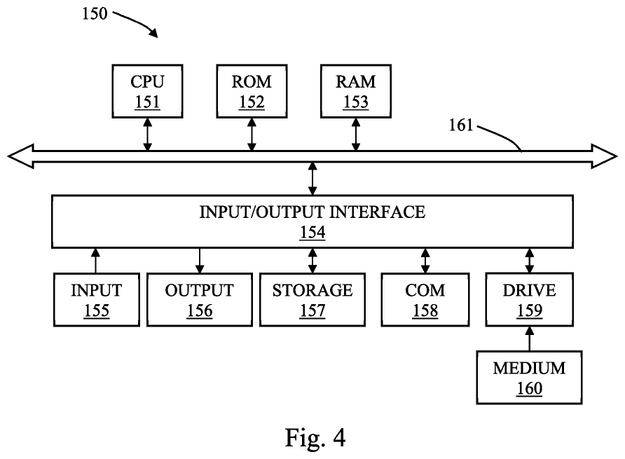

The circuitry of the information processing apparatus may include a control unit, a storage unit and a communication unit. The control unit may include a programmed microprocessor, a field-programmable gate array (FPGA) and/or an application-specific integrated circuit (ASIC). The control unit may perform information processing of the image data captured by the camera as described herein. The control unit may perform the information processing based on instructions stored in the storage unit and/or based on a hardware configuration of the control unit. The storage unit may include a non-volatile section and a volatile section. The non-volatile section may be based on a magnetic storage, on a solid-state drive, on a flash memory, on an electrically erasable programmable read-only memory (EEPROM) or the like and may store the instructions for the control unit, an operating system of the information processing apparatus and/or the image data captured by the camera. The volatile section may be based on dynamic random-access memory (DRAM), extended data output random-access memory (EDO-RAM), fast page mode random-access memory (FPM-RAM) or the like and may store runtime variables, temporary data, and/or the image data captured by the camera. The communication unit may include an interface based on Universal Storage Bus (USB), serial port (RS-232), parallel port, controller area network (CAN) bus, Mobile Industry Processor Interface Alliance (MIPI) Camera Serial Interface (CSI), Ethernet, Wi-Fi (IEEE 802.11 family), 4G/Long Term Evolution (LTE), 5G/New Radio (NR), Bluetooth, Bluetooth Low Energy (BLE), ZigBee or the like. The communication unit may receive the image data from the camera and/or may output the image data (e.g., as received and/or after applying an image processing function), a control signal for an actuator of the information processing apparatus and/or an indication of the determined operation mode. The information processing apparatus may include a general-purpose computer, as described in more detail with reference to FIG. 4.

The information processing apparatus may further include an actuator. The actuator may include a motor, and/or a hydraulic or pneumatic pump and/or valve for controlling a robot, an engine for driving and/or steering a vehicle and/or for flying a drone.

The camera may include a color camera (e.g., a red-green-blue (RGB) camera), a grayscale camera, a time-of-flight (ToF) camera, an event-based vision sensor (EVS), an infrared camera or the like. The camera may capture, as images, single image frames, movies and/or events. The image data may include a sequence of bits and/or bytes that indicate the images captured by the camera. For example, the image data may be formatted according to the Tag Image File Format (TIFF), the Joint Photographic Experts Group (JPEG) format, the Moving Picture Experts Group (MPEG)-4 format, H.263, H.264, High-Definition Multimedia Interface (HDMI), Serial Digital Interface (SDI), Network Device Interface (NDI) or the like. The camera may capture the image data and may provide the image data to the circuitry of the information processing apparatus, e.g., via the communication interface of the information processing apparatus.

The circuitry may analyze the image data captured by the camera for determining whether and to what degree an imaging capability of the camera is physically reduced. The physical reduction of the camera may cause an image degradation (e.g., reduced image quality) of an image captured by the camera. The image data may represent the image and, thus, may also reflect the image quality/degradation of the image. Thus, the circuitry may determine a reduced imaging capability of the camera based on the analysis of the image data, e.g., based on whether and to what degree an image quality of the image data is reduced.

The image degradation may include an internal and/or an external degradation. For example, the image degradation may include a reduced image contrast (e.g., if a scene imaged by the camera is illuminated so low (underexposure) or so high (overexposure) and/or if objects in the scene have so similar colors and/or brightness that a distinction between objects in the scene may be difficult), smoke, mist, fog, dust, condensation, water drops (e.g., due to rain), dirt (e.g., leaves, dust, shavings, swarf) and/or a scratch on a lens of the camera, a misalignment of the lens, a pixel failure of the camera, a column failure of the camera or the like.

Thus, the image degradation may physically reduce an imaging capability of the camera. The imaging capability may include a capability of the camera to capture sharp and focused images with a brightness, contrast and/or dynamic range suitable for performing image recognition. If the imaging capability of the camera is reduced, an image captured by the camera may be less suitable for image recognition, e.g., the image may be blurred or out of focus, may have a low brightness, contrast and/or dynamic range, and/or may have portions that include noise instead of an indication of the scene.

Accordingly, an object detection performed by the circuitry of the information processing apparatus based on the image data may fail if the degree of image degradation is too high. For example, the circuitry may detect in the image data too late or not at all a person who enters an operation area of a robot and/or who is standing in front of a vehicle if the degree of image degradation is too high. For example, if the image degradation is too high, the circuitry may fail to recognize in the image data an object on which a robot should work and/or which the robot should pick up, the circuitry may fail to detect in the image data a course of a route and/or a road sign in front of a vehicle, the circuitry may fail to detect in the image data an obstacle in an operation area of a robot and/or in front of a vehicle or the like.

Therefore, a failure of image recognition due to a high degree of image degradation of images captured by the camera may lead to an accident in which people are injured and/or in which the information processing apparatus and/or another object is damaged.

In order to avoid such injury or damage, the circuitry may determine the degree of image degradation based on the image data captured by the camera and may determine an operation mode of the information processing apparatus based on the determined degree of image degradation. The operation mode may include a normal mode and a safe mode.

For example, the circuitry may determine the normal mode as the operation mode if the determined degree of image degradation is low enough such that an image recognition based on the image data is expected to be possible. The normal mode may include a mode of normal operation of the information processing apparatus based on the image data. In the normal mode, a robot may work on and/or pick up an object in an operation area, a vehicle may move along a route, a drone may fly towards a destination, and/or a surveillance system may surveil a region.

For example, the circuity may determine the safe mode as the operation mode if the determined degree of image degradation is so high that a failure of an image recognition based on the image data is determined to be likely. The safe mode may include a mode in which an operation of the information processing apparatus may be restricted such that a failure of an operation of the information processing apparatus that may cause an accident, an injury of a person and/or a damage of the information processing apparatus and/or of another object may be avoided.

In the safe mode, a robot may stop moving, may move into a rest position and/or may switch an operation unit that could cause damage into a rest state or an off state. For example, in the safe mode, the robot may switch off a soldering unit and/or may close a shutter of a laser unit. In the safe mode, a vehicle may initiate an emergency braking and/or a driver assistance system of the vehicle may issue an alert to a driver of the vehicle that the driver assistance system is restricted due to a high degree of image degradation. In the safe mode, a drone may perform an emergency landing, may fly in a predefined height towards a predefined destination, may switch from an autonomous mode to a controlled mode and/or may issue an alert to an operator or maintainer of the drone that an imaging capability of the camera is physically reduced. In the safe mode, a surveillance system may issue an alert that an imaging capability of the camera is physically reduced.

The circuitry may determine the degree of image degradation periodically, e.g., every 500 milliseconds, every second, every five seconds or the like, without limiting the disclosure to these values. Thus, the circuitry may periodically check the imaging capability of the camera and may determine the safe mode as the operation mode if the degree of image degradation is so high that a malfunction of the information processing apparatus is possible or even likely. However, the circuitry may determine the normal mode as the operation mode if the degree of image degradation is low enough such that an unnecessary interruption of an operation of the information processing apparatus may be avoided. The circuitry may also determine the degree of image degradation at non-periodic points in time, e.g., at random points in time, in case of a predefined correlation between subsequent image frames captured by the camera, and/or in case of inconsistent image recognition results between subsequent image frames.

The degree of image degradation may be represented as a value in the interval from zero to one, from 0% to 100% and/or from 0 to 255, without limiting the disclosure to these values or intervals. The degree of image degradation may indicate a portion of the image that is degraded, an amount of the degradation, a confidence interval of the image data, an estimated probability of a failure of image recognition performed based on the image data or the like. The circuitry may determine the degree of image degradation as a scalar value. The circuitry may determine degrees of various types of image degradation (e.g., brightness conditions, fog, blurriness, pixel/column failure). The degree of image degradation may include a vector that includes the degrees of the various types of image degradation and/or the degree of image degradation may include a scalar value that is based on the degrees (e.g., a maximum of the degrees, a (possibly weighted) average of the degrees, a sigmoid of a (possibly weighted) sum of the degrees or the like) of the various types of image degradation.

In some embodiments, the determination of the degree of image degradation is based on a diagnosis algorithm validated with a plurality of degraded images with known degrees of image degradation.

The diagnosis algorithm may be based on a technique for computer vision, image processing and/or machine vision. The diagnosis algorithm may include detecting, in an image input to the diagnosis algorithm (e.g., in the image represented by the image data and/or in the plurality of degraded images for validation), a noise, a contrast, a brightness, a dynamic range, a line, an edge, a ridge, a corner, a blob, a point, a pattern, a texture, a shape, an object or the like, and/or may include performing rotating, resampling (e.g., changing a pixel number), cropping (e.g., removing a portion of an image), transforming between color models (e.g., from Red-Green-Blue (RGB) to grayscale and/or to Hue-Saturation-Value (HSV) or the like), denoising (e.g., smoothing), image sharpening (e.g., unsharp masking), contrast enhancement, segmentation or the like of the image. The diagnosis algorithm may include processing several copies of the image (or of portions of the image) differently, and comparing the differently processed portions, e.g., based on subtraction.

The diagnosis algorithm may be based on a machine learning model. The machine learning model may include an algorithmic model such as a support vector machine (SVM) or a random forest, and/or may include a deep learning algorithm such as a Feed-Forward Network, a Residual Network (ResNet), a Recurrent Neural Network (RNN), a Convolutional Neural Network (CNN), a Generative Adversarial Network (GAN), a Transformer Neural Network and/or any other suitable neural network architecture.

The diagnosis algorithm may take the image data as input, estimate the degree of image degradation based on the input image data, and output an indication of the estimated degree of image degradation.

The diagnosis algorithm (e.g., an accuracy, a robustness and/or a reliability of the diagnosis algorithm) may have been validated by inputting the plurality of degraded images into the diagnosis algorithm, estimating the degrees of image degradation of the plurality of degraded images with the diagnosis algorithm, comparing the estimated degrees of image degradation with the respective known degrees of image degradation and adjusting parameters of the diagnosis algorithm (e.g., a type, an order and/or an intensity of image processing steps) according to the comparison (e.g., to a result of the comparing).

The validating of the diagnosis algorithm may be performed by the information processing apparatus and/or by a separate apparatus. In the latter case, a decision to use the diagnosis algorithm for estimating the degree of image degradation of the image data may be based on a validation result (e.g., a value indicating an accuracy, a robustness and/or a reliability of the diagnosis algorithm) of the validating. For example, an accuracy of the diagnosis algorithm may be based on a percentage of true positive and/or true negative results among the estimated degrees of image degradation estimated in the validating. For example, the validation result may be based on the comparison (e.g., a result of the comparing) of the estimated degrees of image degradation with the respective known degrees of image degradation.

In a case where the diagnosis algorithm is based on a machine learning model (e.g., an artificial neural network, as mentioned above), the machine learning model may be trained by inputting (at least some of) the plurality of degraded images into the machine learning model, estimating the degrees of image degradation of the plurality of degraded images with the machine learning model, comparing the estimated degrees of image degradation with the respective known degrees of image degradation and adjusting parameters of the machine learning model (e.g., adjusting weights of inputs to neurons of a neural network) according to the comparison (e.g., a result of the comparing). The training may be based on supervised learning, unsupervised learning and/or reinforced learning. The skilled person generally knows how a neural network can be trained. A detailed description of the training of the machine learning model is therefore omitted.

In a case where the diagnosis algorithm is based on (e.g., includes) a machine learning model, the training of the machine learning model may be performed by the information processing apparatus and/or by a separate apparatus. In the latter case, a training result (e.g., optimized values for weights of inputs to neurons) may be transferred to the information processing apparatus.

In some embodiments, the plurality of degraded images is generated by augmenting images with degradations.

For example, undegraded images of one or more scenes may be augmented with image degradations. The image degradations may be based on image processing algorithms. For example, an out-of-focus degradation may be simulated based on applying a Gaussian smoothing filter to an undegraded image. Poor illumination (e.g., too dark or too bright) may be simulated based on scaling pixel values of the image data. A reduced contrast may be simulated by a dynamic range compression. Fog, smoke or dust may be simulated by (possibly partially) overlaying the image data with a color or pattern that has a transparency (which may vary in space and/or time). Pixel or column failure may be simulated by setting values of pixels or columns, respectively, to a corresponding value.

From each undegraded image, multiple degraded images may be derived with varying types and/or degrees of image degradation. A degraded image may include one type of degradation or an arbitrary combination of different types of degradation. A degree of image degradation of the degraded images may be predefined and/or may be chosen randomly.

The degree of image degradation added by augmenting an undegraded image may be based on a parameter of an image processing algorithm and, thus, may be known. Therefore, the degree of image degradation of the plurality of degraded images may be known, such that an accuracy of the diagnosis algorithm may be easily evaluated and the diagnosis algorithm may be validated efficiently. In a case where the diagnosis algorithm is based on a machine learning model, the machine learning model may also be trained more efficiently if the degree of image degradation of (at least some of) the plurality of degraded images used for the training is known.

In some embodiments, the determining of the operation mode includes: determining, based on the determined degree of image degradation, whether a performance criterion of the information processing apparatus is fulfilled; and determining the operation mode based on the determination whether the performance criterion is fulfilled.

The performance criterion may indicate whether an operation of the information processing apparatus that is based on the image data is expected to function properly or whether a failure of the operation (e.g., an accident that causes an injury of a human and/or a damage of the information processing apparatus and/or of another object) is likely.

The performance criterion may be based on an estimated probability that the operation of the information processing apparatus fails.

The determination whether the performance criterion is fulfilled may correspond to a result of the determining whether the performance criterion is fulfilled and, thus, to an indication whether the performance criterion is fulfilled. For example, the determination may be represented by a Boolean value (e.g., True or False).

The circuitry may determine the normal mode as the operation mode if the performance criterion is fulfilled and may determine the safe mode as the operation mode if the performance criterion is not fulfilled.

In some embodiments, the determining whether the performance criterion is fulfilled includes determining that the performance criterion is not fulfilled if the determined degree of image degradation exceeds a degradation threshold.

If the determined degree of image degradation does not exceed the degradation threshold, the circuitry may determine that the performance criterion is fulfilled.

In some embodiments, the performance criterion is based on a performance threshold for a performance indicator that indicates a performance of the information processing apparatus; and the degradation threshold is based on an intersection point of the performance indicator with the performance threshold.

An example of the performance indicator is a key performance indicator (KPI) of the image processing apparatus.

The performance indicated by the performance indicator may include a capability of the circuitry to detect a person in an operation area of a robot and/or in front of a vehicle, to detect an object to be worked on or picked up by a robot, to detect a course of a route, a traffic situation and/or a traffic sign in a surrounding of a vehicle, to detect a person entering a surveilled area and/or to detect an object with which an collision should be avoided.

The performance threshold may be predefined and may be chosen to separate values of the performance indicator that indicate that the performance criterion is fulfilled from values of the performance indicator that indicate that the performance criterion is not fulfilled.

The degradation threshold may be chosen based on a dependency of the performance indicator from a degree of image degradation represented by the image data. The performance indicator may indicate for a first interval of degrees of image degradation that the performance criterion is fulfilled and for a second interval of degrees of image degradation that the performance criterion is not fulfilled. The intersection point of the performance indicator with the performance threshold may correspond to a degree of image degradation that separates the first interval from the second interval.

In some embodiments, the degradation threshold lies a predefined safety margin before the intersection point.

The degradation threshold may be chosen such that the circuitry determines the safe mode as the operation mode at a determined degree of image degradation that is lower than a degree of image degradation that corresponds to the intersection point in order to account for an uncertainty of determining a degree of image degradation and/or for an uncertainty of the performance indicator. Accordingly, the safety margin may be chosen based on a confidence interval and/or standard deviation of the determined degree of image degradation and/or of the performance indicator. The safety margin may also be chosen according to a derivative of the performance indicator with respect to the degree of image degradation, e.g., the steeper the slope, the smaller the safety margin may be chosen.

In some embodiments, the performance indicator is based on a performance of the information processing apparatus measured during an operation of the information processing apparatus based on a plurality of degraded images with known degrees of image degradation input to the information processing apparatus.

For determining the performance indicator, an image recognition routine based on which the information processing apparatus controls its operation may be executed for the plurality of degraded images. The executing of the image recognition routine may include determining whether the image recognition routine properly detects a person, an object, an obstacle, a vehicle route, a traffic sign or the like shown in the plurality of degraded images.

For the determining of the performance indicator, the information processing apparatus may switch to a simulation mode in which the information processing apparatus operates the image recognition routine but does not drive an actuator.

The plurality of degraded images for determining the performance indicator may be generated based on undegenerated images, as described above with respect to the plurality of degraded images for validating the diagnosis algorithm. The performance indicator may be determined based on the same plurality of degraded images based on which the diagnosis algorithm is validated (and/or based on which a machine learning model is trained in a case where the diagnosis algorithm is based on a machine learning model), or based on a different plurality of degraded images.

The performance indicator may be determined based on a histogram and/or kernel density of the measured values of the performance indicator with respect to the known degrees of image degradation of the plurality of degraded images, and/or based on fitting (e.g., based on least-squares estimation or, generally, on maximum-likelihood estimation) a predefined function (e.g., a set of spline segments, an (inverted) sigmoid function, a suitable probability distribution or the like) to the measured values of the performance indicator with respect to the respective known degrees of image degradation.

Thus, the performance indicator may be determined as a function of the degree of image degradation.

In some embodiments, the circuitry is further configured to determine a safe mode as the operation mode when determining that the performance criterion is not fulfilled.

In the safe mode, the information processing apparatus may operate in a way to avoid an injury of a person in a surrounding of the information processing apparatus and/or to avoid a damage of the information processing apparatus and/or another object in the surrounding of the information processing apparatus. For example, as described above, the information processing apparatus may switch, in the safe mode, an actuator of the information processing apparatus into a rest or standby or off mode.

Thus, an injury of a person and/or a damage of the information processing apparatus and/or of another object may be avoided even in a case if the imaging capability of the camera is physically reduced such that the information processing apparatus cannot properly sense and take care of its surrounding.

In some embodiments, the camera is included in the information processing apparatus.

The information processing apparatus may sense its surrounding by imaging the surrounding with the camera and control an operation of (e.g., an actuator of) the information processing apparatus based on the sensed surrounding.

Some embodiments pertain to an information processing method that includes: obtaining image data captured with a camera; determining a degree of image degradation based on the obtained image data, wherein the degree of image degradation indicates a degree of a physical reduction of an imaging capability of the camera; and determining, based on the determined degree of image degradation, an operation mode of an information processing apparatus.

The information processing method may be performed by the information processing apparatus described above. Accordingly, the features described above with respect to the information processing apparatus may correspond to respective features of the information processing method.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, FIG. 1 illustrates an information processing apparatus 1 according to an embodiment.

The information processing apparatus 1 includes a control unit 2, a storage unit 3, a communication unit 4, a camera 5 and an actuator 6.

The information processing apparatus 1 is configured as a robot. The control unit 2 includes a programmed microprocessor that controls an operation of the information processing apparatus 1 and, in particular, of the actuator 6. The actuator 6 includes a motor 6a for picking up an operation object, working on the operation object and depositing the operation object. The actuator 6 further includes a motor 6b for locomotion. The motors 6a and 6b are an example of an operation unit of the robot.

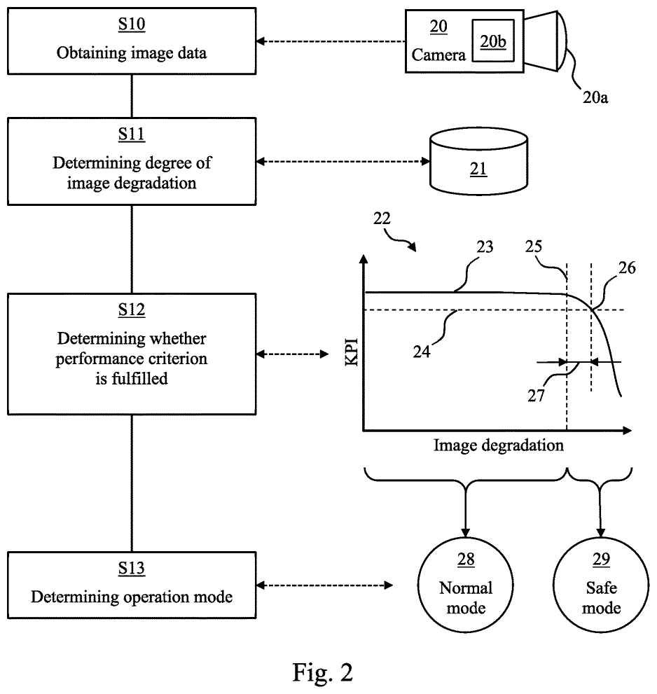

The storage unit 3 stores a program for the control unit 2. The program includes instructions for determining, according to the method of FIG. 2, an operation mode of the information processing apparatus 1 based on a degree of image degradation indicated by image data captured by the camera 5. The program further includes instructions for controlling the information processing apparatus 1 and, in particular, the actuator 6 according to the image data captured by the camera 5 and according to the determined operation mode. The storage unit 3 also stores a diagnosis algorithm 3a for determining a degree of image degradation based on the image data captured by the camera 5. An accuracy of the diagnosis algorithm has been validated with a plurality of degraded images with known degrees of image degradation.

The communication unit 4 includes an HDMI interface for receiving from the camera 5 the image data captured by the camera 5.

The camera 5 includes a lens 5a and an imaging sensor 5b. The lens 5a focuses incident light on the imaging sensor 5b. The incident light comes from a scene in a surrounding of the information processing apparatus 1. The imaging sensor 5b includes a plurality of pixels. Each pixel of the plurality of pixels accumulates photoelectric charges generated based on light focused by the lens 5a on the respective pixel. The camera 5 generates image data based on the photoelectric charges accumulated by the plurality of pixels and outputs the generated image data via an HDMI interface to the communication unit 4.

It is noted that, in some embodiments, the information processing apparatus 1 is configured as a vehicle, e.g., as an autonomous vehicle or as a vehicle with a driver assistance system, and the actuator 6 includes a traction engine 6a for controlling a speed of the vehicle and a steering motor 6b for controlling a driving direction of the vehicle. In such embodiments, the camera 5 captures images of a surrounding of the vehicle, e.g., from a route ahead of the vehicle.

Further, in some embodiments, the information processing apparatus 1 is configured as a drone, wherein the actuator 6 includes engines 6a and 6b for driving rotors of the drone. The drone may have four engines and rotors, without limiting the disclosure thereto. In such embodiments, the camera 5 captures images of a surrounding of the drone and/or of a ground below the drone.

It is also noted that, in some embodiments, the information processing apparatus 1 is configured as a surveillance system that may include a plurality of cameras each configured like the camera 5. The camera(s) 5 may capture images of a predefined area (e.g., a building, a road, a parking area, a production facility or the like). The surveillance system may store the image data in the storage unit 3 and/or output the image data via the communication unit 4. The surveillance system may analyze the image data for detecting a predefined incident (e.g., an accident and/or an unauthorized intrusion) and may perform a predefined action (e.g., trigger an alarm) if an incident is detected based on the image data.

Note that, in some embodiments, the diagnosis algorithm 3a is based on a machine learning model. In such embodiments, the machine learning model may include an artificial neural network that has been trained based on the plurality of degraded images with known degrees of image degradation.

FIG. 2 illustrates an information processing method according to an embodiment. The method is an example of a method performed by the information processing apparatus 1 of FIG. 1.

The method includes obtaining, at S10, image data captured with a camera 20. The camera 20 corresponds to the camera 5 of FIG. 1 and, accordingly, includes a lens 20a and an imaging sensor 20b with pixels. The image data represent an image of a surrounding of the information processing apparatus 1.

The method includes determining, at S11, a degree of image degradation based on the image data obtained at S10. The degree of image degradation indicates a degree of a physical reduction of an imaging capability of the camera 20. The determining of the degree of image degradation is based on a diagnosis algorithm 21, which corresponds to the diagnosis algorithm 3a of FIG. 1.

The information processing apparatus 1 provides the image data as input to the diagnosis algorithm 21 and executes the diagnosis algorithm 21. The diagnosis algorithm 21 estimates and returns the degree of image degradation.

The degree of image degradation corresponds to a degradation of an image captured by the camera 20 and indicates a degree of a physical reduction of an imaging capability of the camera 20. The diagnosis algorithm 21 is configured to detect various predefined types of image degradation, including an underexposure or an overexposure caused by adverse illumination conditions, a decreased contrast caused by fog or dust, an image artefact caused by a water condensation or dirt on the lens 20a, and missing image portions caused by pixel failure or column failure in the imaging sensor 20b. The diagnosis algorithm 21 estimates, based on the image data, how strong the image captured by the camera 20 is subject to each respective predefined type of image degradation, and determines the degree of image degradation based on a result of the estimating.

The diagnosis algorithm 21 is validated with a plurality of degraded images with known degrees of image degradation. The plurality of degraded images is generated by augmenting undegraded images with degradations of various predefined types and degrees. The degrees of image degradation of the plurality of degraded images are known from parameters of image processing algorithms that are used for the augmenting.

At S12, the method includes determining whether a performance criterion of the information processing apparatus 1 is fulfilled.

The diagram 22 illustrates the performance criterion. The performance criterion is based on a key performance indicator (KPI) 23 of the information processing apparatus 1. The KPI 23 is an example of a performance indicator and indicates, in the embodiment of FIG. 2, an ability of the information processing apparatus 1 to operate properly based on the image data, which is an example of a performance of the information processing apparatus 1. The KPI 23 depends on the degree of image degradation and drops if the degree of image degradation increases.

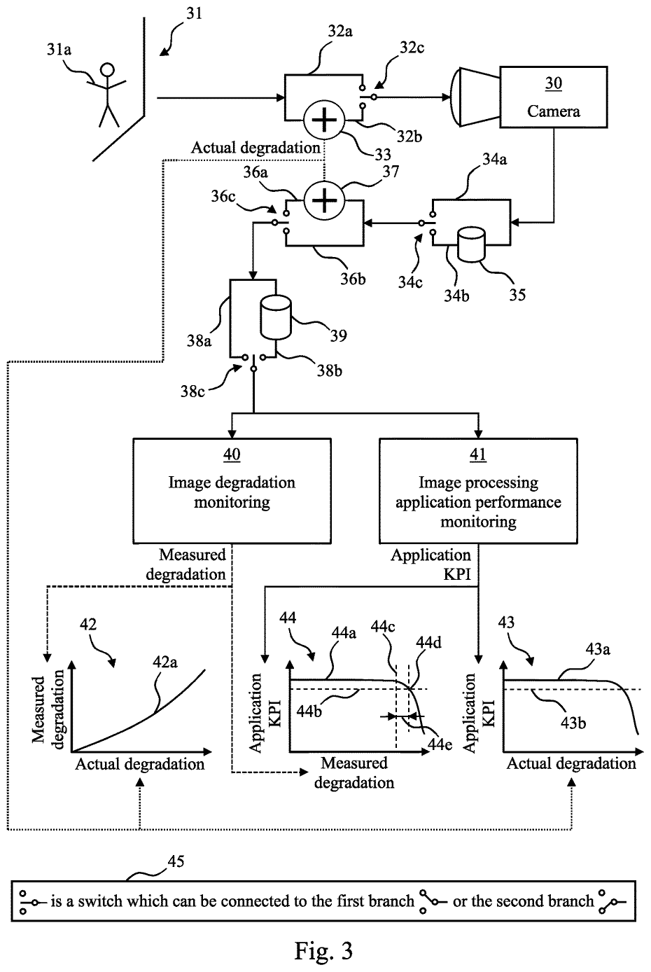

The KPI 23 is based on a performance of the information processing apparatus 1 measured during an operation of the information processing apparatus 1 based on a plurality of degraded images with known degrees of image degradation input to the information processing apparatus 1. A detailed example of determining the dependency between the KPI 23 and the degree of image degradation is described with reference to FIG. 3.

The diagram 22 shows the KPI 23 as a function of the determined degree of image degradation determined at S11. The performance criterion is based on a performance threshold 24 for the KPI 23. As long as the KPI 23 remains above the performance threshold 24, an operation of the information processing apparatus 1 based on the image data is expected to be safe. If the KPI 23 drops below the performance threshold 24, the operation of the information processing apparatus 1 is considered to be unsafe and a probability of an accident caused by the information processing apparatus 1 increases.

For determining at S12 based on the degree of image degradation whether the performance criterion is fulfilled, the information processing apparatus 1 compares the determined degree of image degradation to a degradation threshold 25. If the determined degree of image degradation is below the degradation threshold 25, the information processing apparatus 1 determines that the performance criterion is fulfilled. If the determined degree of image degradation exceeds the degradation threshold 25, the information processing apparatus 1 determines that the performance criterion is not fulfilled.

The degradation threshold 25 is based on an intersection point 26 of the KPI 23 with the performance threshold 24. The degradation threshold 25 is chosen such that the degradation threshold 25 lies a predefined safety margin 27 before the intersection point 26. The safety margin 27 is determined based on a standard deviation of the KPI 23 and on an accuracy of the diagnosis algorithm 21. The safety margin 27 is positive, i.e., the degradation threshold 25 is shifted from the intersection point 26 in a direction of lower degrees of image degradation. The degradation threshold 25 is stored in the storage unit 3 of FIG. 1 of the information processing apparatus 1 and is read from the storage unit 3 for the determining at S12.

The method further includes determining, at S13, an operation mode of the information processing apparatus 1 based on the degree of image degradation determined at S11 and based on the determination at S12 whether the performance criterion is fulfilled.

If the determined degree of image degradation is lower than the degradation threshold 25 (and, accordingly, the KPI 23 is above the performance threshold 24), the performance criterion is fulfilled and an operation of the information processing apparatus 1 based on the image data is expected to be safe. In such a case, the information processing apparatus 1 determines, as the operation mode, a normal mode 28 in which the information processing apparatus 1 operates based on the image data.

However, if the determined degree of image degradation exceeds the degradation threshold 25, the performance criterion is not fulfilled and, accordingly, an operation of the information processing apparatus 1 based on the image data is considered unsafe. In such a case, the information processing apparatus 1 determines, as the operation mode, a safety mode 29, which is an example of a safe mode. In the safety mode 29, the information processing apparatus 1 stops an operation based on the image data that may cause harm or damage if the information processing apparatus 1 fails to properly sense its surroundings based on the image data.

FIG. 3 illustrates a method of determining an ability of an image degradation monitor to detect an image degradation according to an embodiment. The method may be performed by the information processing apparatus 1 of FIG. 1 and/or by the general-purpose computer of FIG. 4.

The method allows, in some embodiments, validating an ability of a camera malfunction diagnostic performed by the image degradation monitor to detect image quality degradations before they impact (too much) a performance of an application using the image. The image degradation monitor may include the information processing apparatus 1, and the camera malfunction diagnostic may include the method of FIG. 2 or parts thereof. The application using the image may include an application/program that is stored in the storage 3 of FIG. 1 and that is executed by the control unit 2 of FIG. 1 for controlling an operation of the information processing apparatus 1 based on image data that represent an image of a surrounding of the information processing apparatus 1, e.g., for sensing the surrounding of the information processing apparatus 1 based on the image data.

The camera malfunction diagnostic is configured to detect an image quality degradation of an image captured by a camera 30 from a scene 31. The camera 30 corresponds to the camera 5 of FIG. 1 and/or to the camera 20 of FIG. 2. The scene 31 corresponds to a surrounding of the camera 30 (e.g., to a surrounding of the information processing apparatus 1) and, in the case depicted in FIG. 3, includes a person 31a. The application is required to detect, based on image data captured by the camera 30, that the person 31a is present in the scene 31 such that the information processing apparatus 1 can avoid injuring the person 31a.

The camera 30 captures image data that represent an image of the scene 31. A first capturing branch 32a illustrates a case where an imaging capability of the camera 30 is not reduced and an image quality of the image represented by the image data is not degraded, i.e., a degree of image degradation of the image is low (e.g., zero, without limiting the disclosure thereto).

A second capturing branch 32b illustrates a case where an imaging capability of the camera 30 is physically reduced such that a physical image quality degradation 33 is present and the camera 30 directly captures image data that represent an image with the physical degradation 33. The physical image quality degradation 33 may be caused by overexposure, underexposure, smoke, fog, dust, dirt or water condensation on a lens of the camera 30, out-of-focus, pixel failure of the camera 30, column failure of the camera 30, or the like, as described above. The physical image degradation 33 is an example of an actual degradation.

A switch 32c illustrates that the camera 30 may capture image data without a physical image degradation 33 (i.e., according to the first capturing branch 32a) or image data with a physical image degradation 33 (i.e., according to the second capturing branch 32b).

As described in explanation box 45, switches (such as the switch 32c) in FIG. 3 illustrate alternatives that can be realized by connecting the respective switch in analogy to an electric circuit to a first branch that represents a first alternative or to a second branch that represents a second alternative.

The camera captures test image data for performing the method. The test image data may represent single image frames (pictures) and/or movies. According to a first alternative, the camera 30 outputs the test image data directly through a first image source branch 34a.

According to a second alternative, the camera 30 provides the test image data to a native image database 35 on a second image source branch 34b. The native image database 35 may store the test image data from the camera 30. The native image database 35 may also store test image data from other cameras and/or from other scenes than the scene 31 and/or may store test image data that have been generated synthetically. The native image database 35 outputs test image data stored therein (which may include pictures and/or movies) on the second image source branch 34b.

A switch 34c shows that the method can be based on anyone of the first image source branch 34a and the second image source branch 34b. Thus, the method may be performed based on live test image data (i.e., according to the first image source branch 34a) or based on stored and/or replayed test image data (i.e., according to the second image source branch 34b).

According to a first alternative illustrated by a first augmentation branch 36a, the test image data from the switch 34c is augmented with a synthetic image degradation 37 for obtaining degraded test image data. The degraded test image data may include pictures and/or movies. The augmenting includes applying image degradations of various types and characteristics to the test image data from the switch 34c. The applying of the synthetic image degradation 37 may be based on image processing routines, e.g., on blurring the test image data with a filter with a predefined radius. Parameters of the image processing routines may be predefined and/or may be chosen randomly. The synthetic image degradation 37 may simulate the physical image degradations 33 applied in the second capturing branch 32b. The synthetic image degradation 37 is an example of an actual degradation.

According to a second alternative illustrated by a second augmentation branch 36b, the test image data from the switch 34c are not augmented with further image degradations.

A switch 36c illustrates that the method can be based on anyone of the first augmentation branch 36a and the second augmentation branch 36b. For example, the first augmentation branch 37 may be selected if the test image data are based on the first capturing branch 32a, and the second augmentation branch 36b may be selected if the test image data are based on the second capturing branch 32b, such as to avoid applying a synthetic degradation 37 to an image that already includes a physical degradation 33. However, in some embodiments, a combination of a physical degradation 33 and a synthetical degradation 37 (i.e., of the second capturing branch 32b and the first augmentation branch 36a) and/or a test image data without a physical degradation 33 and without a synthetical degradation 37 (i.e., a combination of the first capturing branch 32a and the second augmentation branch 36b) is selected. The switch 36c outputs degraded test image data from the first or second augmentation branch 36a or 36b.

According to an alternative illustrated by a first output branch 38a, the method is performed based on live degraded test image data. According to an alternative illustrated by a second output branch 38b, the degraded test image data from the switch 36c is stored in an augmented image database 39, and degraded test image data (including pictures and/or movies) is replayed from the augmented image database 39. A switch 38c shows that the method can be performed based on anyone of the first output branch 38a and the second output branch 38b.

The switch 38c provides the degraded test image data (including pictures and/or movies) to an image degradation monitoring 40 and to an image processing application performance monitoring 41.

The image degradation monitoring 40 determines, based on a diagnosis algorithm such as the diagnosis algorithm 3a of FIG. 1 and/or the diagnosis algorithm 21 of FIG. 2, a degree of image degradation based on the degraded test image data provided to the image degradation monitoring 40. In the method of FIG. 3, the image degradation monitoring 40 is executed under test for determining an ability of the image degradation monitor that executes the image degradation monitoring 40 to detect an image degradation based on input image data. The image degradation monitoring 40 outputs an estimated degree of image degradation. The output of the image degradation monitoring 40 is also referred to as measured degradation.

The image processing application performance monitoring 41 executes an image processing application of the information processing apparatus 1. The image processing application may sense a surrounding of the information processing apparatus 1, based on image data input to the image processing application, such that the information processing apparatus 1 may control an operation of the information processing apparatus 1 based on a result of the sensing and may, for example, avoid an accident, e.g., avoid injuring a person and/or avoid damaging itself and/or another object. In the method of FIG. 3, the image processing application performance monitoring 41 executes the image processing application under test, which includes inputting the degraded test image data from the switch 38c to the image processing application and determining whether the image processing application fails. The image processing application performance monitoring 41 determines and outputs a key performance indicator (KPI) of the image processing application. The KPI is an example of a performance indicator and indicates whether the image processing application properly detects a person (e.g., the person 31a) and/or an object in the scene 31. The image processing application may be executed under test by the control unit 2 of FIG. 1 and/or by a separate circuitry, which may be included in the general-purpose computer described with reference to FIG. 4. In some embodiments, an operation of the information processing apparatus 1 based on an image recognition result of the image processing application is executed and/or simulated, and the KPI may be determined based on a result (e.g., failure or success) of the executing and/or simulating.

A diagram 42 illustrates how the image degradation monitor under test is evaluated for its ability to detect and characterize the image degradation, by comparing the characteristics of the measured degradation measured by the image degradation monitoring 41 against actual characteristics of an actual degradation (e.g., the physical image degradation 33 and/or the synthetical image degradation 37) that has been applied to the test image data (pictures and/or movies). A curve 42a illustrates an example of a correlation between the actual degradation and the measured degradation.

A diagram 43 illustrates the KPI 43a of the image processing application that has been determined by the image processing application performance monitoring 41 based on the degraded test image data in dependency of the actual degradation (i.e., the physical image degradation 33 and/or the synthetical image degradation 37) of the degraded test image data. The diagram 43 further shows a performance threshold 43b for the KPI 43a. An operation of the information processing apparatus 1 is considered unsafe if the KPI 43a drops below the performance threshold 43b. Thus, the image degradation monitor may be required to detect an image degradation before the KPI 43a drops below the performance threshold 43b. Based on the dependency between the actual degradation and the KPI 43a, an adequation of the image degradation monitoring 41 under test to the image processing method under test may be evaluated by the ability of the image degradation monitor to detect and characterize an image degradation based on image data before the image degradation impacts significantly a performance of the image processing application and/or of an operation of the information processing apparatus 1.

A diagram 44 illustrates how the image processing application under test is evaluated for its ability to withstand an image degradation of an image represented by image data input to the image processing application with little degradation of a performance of the image processing apparats. The diagram 44 shows the KPI 44a of the image processing application as determined by the image processing application performance monitoring 41 in dependency of the measured degradation as determined by the image degradation monitoring 40. The dependency of the KPI 44a from the measured degradation is determined based on the dependency of the KPI 43a from the actual degradation, as illustrated in the diagram 43, in combination with the correlation between the actual degradation and the measured degradation, as illustrated in the diagram 42. The KPI 44a may be based on an output of the “deterioration” database and an output of the application.

The diagram 44 corresponds to the diagram 22 of FIG. 2 and further shows the performance threshold 44b (which also corresponds to the performance threshold 43b of the diagram 43), the degradation threshold 44c, the intersection point 44d of the KPI 44a with the performance threshold 44b, and the safety margin 44e, which are described in detail with respect to the diagram 22 of FIG. 2.

Accordingly, the method may correlate the estimated (measured) degree of image degradation of test image data (e.g., the degraded test image data from the switch 38c) with the actual degree of image degradation of the test image data (as shown in diagram 42), wherein the estimated degree of image degradation may be estimated by an image degradation monitor. The image degradation monitor may be based on the diagnosis algorithm 3a of FIG. 1 and/or on the diagnosis algorithm 21 of FIG. 2.

The method may then obtain a dependency of a performance indicator (e.g., of the KPI 43a) from the actual degree of image degradation. The performance indicator may indicate a result of processing the test image data with an image processing application. The image processing application may include an application executed by the information processing apparatus 1 for sensing its surrounding in order to avoid an accident.

The method may determine, based on the obtained dependency (between the performance indicator and the actual degree of image degradation) and on the correlation (between the estimated degree of image degradation and the actual degree of image degradation), whether the estimated degree of image degradation allows determining whether the performance indicator fulfills a performance criterion. The performance criterion may be based on a performance threshold. The performance criterion may be fulfilled if the estimated degree of image degradation is below a degradation threshold (e.g., the degradation threshold 44c), and the performance criterion may be not fulfilled if the estimated degree of image degradation exceeds the degradation threshold. The degradation threshold may be chosen such that the performance indicator does not drop below a performance threshold (e.g., the performance threshold 44b) if the estimated degree of image degradation does not exceed the degradation threshold. The method may further generate the test image data by applying an image degradation (e.g., the synthetic image degradation 37) to image data. A degree of the image degradation applied to the test image data may be known, e.g., based on a parameter of an algorithm that applies the image degradation to the image data. The method may be performed by a circuitry, e.g., by the control unit 2 of FIG. 1 and/or by the general-purpose computer described with reference to FIG. 4.

Thus, the present technology may provide a method for optimizing and/or validating an adequation of different image degradation monitors and their ability to detect a degradation of an image below a level at which it may deteriorate too much an application performance and, e.g., may make the application unsafe. The method may allow verifying whether/when such degradations lower too much the performance of the application, whether the application can be improved to better withstand the image degradation (e.g., by augmenting a machine learning training with degraded images), and/or whether an image quality diagnosis is able to detect and characterize an image degradation.

With the present technology, it may be possible to decide when a degradation is minor such that a safety feature of the application is not impacted and when a degradation impacts the safety feature too badly such that the safety feature is compromised. Thus, it is possible in some embodiments to provide degradation models that can be used to make the application more robust and relax constraints on a camera.

Examples of image degradations that may be considered include contrast, smoke, mist, pixel failure, column failure, or the like.

This approach may particularly be important in a safety environment, in which cameras may be required to be able to self-diagnose and go in safe mode (and/or trigger a safe mode) when a situation occurs that could lead to a failure to danger, e.g., if an undetected condensation on a lens of a camera leads to a cloudy image that could cause a robot/worker proximity image processing application to fail to detect a dangerous proximity between a robot and a worker.

For such a situation, it is key in some embodiments to prove that self-diagnostics of the camera are able to detect that an image quality of images captured by the camera is too degraded and that, hence, the camera cannot be relied upon. In some embodiments, it is required to avoid erring so much on a side of cautions that, e.g., small dirt on the lens of the camera that does not cause a lowering of a detection level causes an extraneous interruption of the robot when there is no danger.

The present technology is in some embodiments linked to machine learning (where the degradation may be seen as a data augmentation of graduated real case failures).

A method according to an embodiment follows the flow described below, varies a type and characteristics of an image degradation and analyzes the following quantities:

The method may analyze a correlation (and a discrimination matrix) between a presence and characteristics of the image degradation and a detection and characterization of the image degradation by an image degradation monitor (as shown in the diagram 42), to validate the image degradation monitor independently of the application.

The method may analyze a relation between the actual presence and characteristics of the image degradation and a performance of the application, to validate the application independently of the image degradation monitor (as shown in the diagram 43).

The method may analyze a relation between the measured presence and characteristics of the image degradation and the performance of the application, to verify, e.g., that the image degradation monitor is sensible enough to detect the presence of the image degradation before the application performance is impacted (as shown in the diagram 44).

The present technology may provide advantages over a test plan that splits a test in two, testing on the one hand that an image processing application can withstand a specified image degradation and on the other hand that an image degradation monitor can detect a specified image degradation, wherein a specification of the specified image degradation is chosen beforehand without measuring a robustness of the image processing application, a sensitivity of the image degradation monitor and their adequation. Such a test plan may result in a poor engineering trade-off and, thus, in systems that are more complex, expensive and restrictive than needed, if at all feasible.

In contrast to such a test plan, the present disclosure may provide an approach to measure a maximum allowed camera image degradation according to requirements an image processing application. The present disclosure may also provide an approach to guarantee that a camera image degradation is detected before a performance of the image processing application is degraded too much. Further, the present disclosure may provide camera image degradation models that can be used to make the image processing application more robust and relax constraints on a camera.

FIG. 4 illustrates an embodiment of a general-purpose computer 150. The computer 150 can be implemented such that it can basically function as any type of information processing apparatus, for example, the information processing apparatus 1 of FIG. 1. The computer 150 has components 151 to 161, which can form a circuitry, such as a circuitry of the information processing apparatus 1 of FIG. 1 (e.g., the control unit 2, the storage unit 3 and/or the communication unit 4), as described herein.

Embodiments which use software, firmware, programs or the like for performing the methods as described herein can be installed on computer 150, which is then configured to be suitable for the concrete embodiment.

The computer 150 has a CPU 151 (Central Processing Unit), which can execute various types of procedures and methods as described herein, for example, in accordance with programs stored in a read-only memory (ROM) 152, stored in a storage 157 and loaded into a random-access memory (RAM) 153, stored on a medium 160 which can be inserted in a respective drive 159, etc.

The CPU 151, the ROM 152 and the RAM 153 are connected with a bus 161, which in turn is connected to an input/output interface 154. The number of CPUs, memories and storages is only exemplary, and the skilled person will appreciate that the computer 150 can be adapted and configured accordingly for meeting specific requirements which arise, when it functions as a base station or as user equipment (end terminal).

At the input/output interface 154, several components are connected: an input 155, an output 156, the storage 157, a communication interface 158 and the drive 159, into which a medium 160 (compact disc, digital video disc, compact flash memory, or the like) can be inserted.

The input 155 can be a pointer device (mouse, graphic table, or the like), a keyboard, a microphone, a camera, a touchscreen, an eye-tracking unit etc.

The output 156 can have a display (liquid crystal display, cathode ray tube display, light emittance diode display, etc.; e.g., included in a touchscreen), loudspeakers, etc.

The storage 157 can have a hard disk, a solid-state drive, a flash drive and the like.

The communication interface 158 can be adapted to communicate, for example, via a local area network (LAN), wireless local area network (WLAN), mobile telecommunications system (GSM, UMTS, LTE, NR etc.), Bluetooth, near-field communication (NFC), infrared, etc.

It should be noted that the description above only pertains to an example configuration of computer 150. Alternative configurations may be implemented with additional or other sensors, storage devices, interfaces or the like. For example, the communication interface 158 may support other radio access technologies than the mentioned UMTS, LTE and NR.

The technology according to an embodiment of the present disclosure is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like.

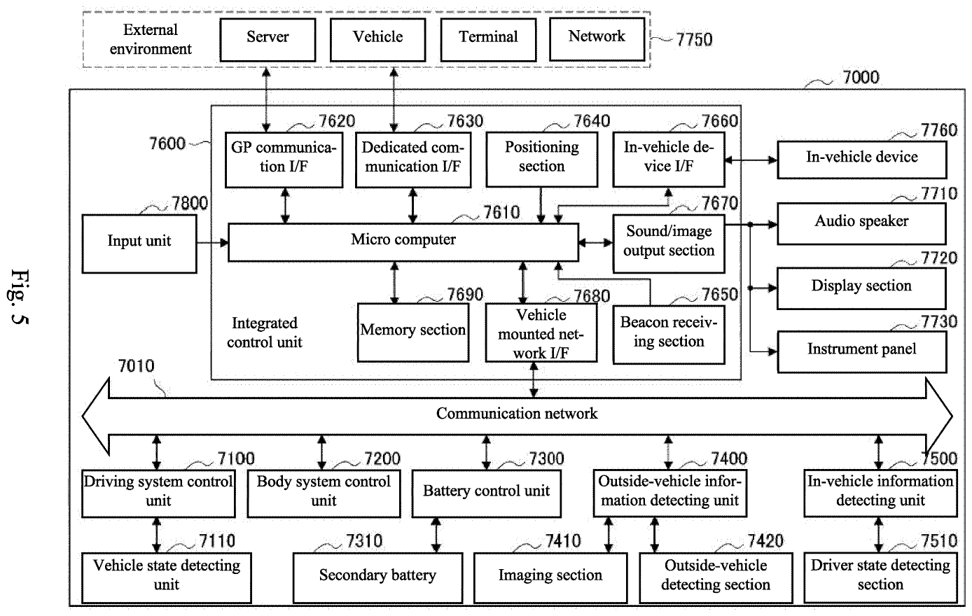

FIG. 5 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 5, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 5 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

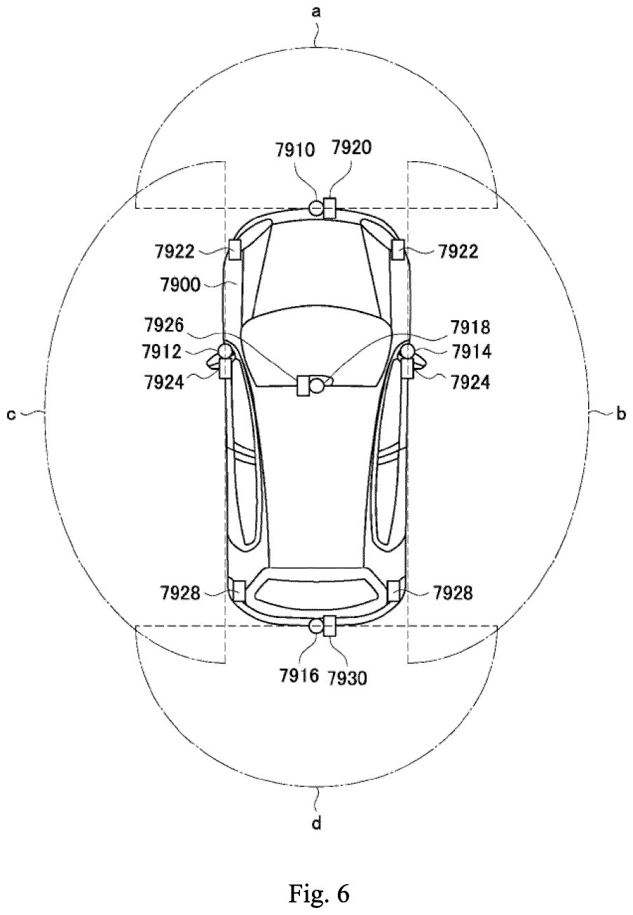

FIG. 6 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900.

The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 6 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 5, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 5, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 5 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing device 100 according to the present embodiment described with reference to FIG. 5 can be implemented in one of the control units or the like. In addition, a computer readable recording medium storing such a computer program can also be provided. The recording medium is, for example, a magnetic disk, an optical disk, a magneto-optical disk, a flash memory, or the like. In addition, the above-described computer program may be distributed via a network, for example, without the recording medium being used.

It should be recognized that the embodiments describe methods with an exemplary ordering of method steps. The specific ordering of method steps is however given for illustrative purposes only and should not be construed as binding. Changes of the ordering of method steps may be apparent to the skilled person.

Please note that the division of the information processing apparatus 1 into units 2 to 6 is only made for illustration purposes and that the present disclosure is not limited to any specific division of functions in specific units. For instance, the information processing apparatus 1 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An information processing apparatus, comprising circuitry configured to:
obtain image data captured with a camera;
determine a degree of image degradation based on the obtained image data, wherein the degree of image degradation indicates a degree of a physical reduction of an imaging capability of the camera; and
determine, based on the determined degree of image degradation, an operation mode of the information processing apparatus.

(2) The information processing apparatus of (1),
wherein the determination of the degree of image degradation is based on a diagnosis algorithm validated with a plurality of degraded images with known degrees of image degradation.

(3) The information processing apparatus of (2), wherein the validating of the diagnosis algorithm includes:
inputting the plurality of degraded images into the diagnosis algorithm;
estimating, with the diagnosis algorithm, degrees of image degradation of the plurality of degraded images; and
comparing the estimated degrees of image degradation with the respective known degrees of image degradation.

(4) The information processing apparatus of (3),
wherein the validating includes adjusting a parameter of the diagnosis algorithm according to the comparison.

(5) The information processing apparatus of any one of (2) to (4),
wherein the plurality of degraded images is generated by augmenting images with degradations.

(6) The information processing apparatus of any one of (1) to (5), wherein the determining of the operation mode includes:
determining, based on the determined degree of image degradation, whether a performance criterion of the information processing apparatus is fulfilled; and
determining the operation mode based on the determination whether the performance criterion is fulfilled.

(7) The information processing apparatus of (6),
wherein the determining whether the performance criterion is fulfilled includes determining that the performance criterion is not fulfilled if the determined degree of image degradation exceeds a degradation threshold.

(8) The information processing apparatus of (7),
wherein the performance criterion is based on a performance threshold for a performance indicator that indicates a performance of the information processing apparatus; and
wherein the degradation threshold is based on an intersection point of the performance indicator with the performance threshold.

(9) The information processing apparatus of (8),
wherein the degradation threshold lies a predefined safety margin before the intersection point.

(10) The information processing apparatus of (8) or (9),
wherein the performance indicator is based on a performance of the information processing apparatus measured during an operation of the information processing apparatus based on a plurality of degraded images with known degrees of image degradation input to the information processing apparatus.

(11) The information processing apparatus of any one of (6) to (10),
wherein the circuitry is further configured to determine a safe mode as the operation mode when determining that the performance criterion is not fulfilled.

(12) The information processing apparatus of any one of (1) to (11),
wherein the camera is included in the information processing apparatus.

(13) An information processing method, comprising:
obtaining image data captured with a camera;
determining a degree of image degradation based on the obtained image data, wherein the degree of image degradation indicates a degree of a physical reduction of an imaging capability of the camera; and
determining, based on the determined degree of image degradation, an operation mode of an information processing apparatus.

(14) The information processing method of (13),
wherein the determination of the degree of image degradation is based on a diagnosis algorithm validated with a plurality of degraded images with known degrees of image degradation.

(15) The information processing method of (14), wherein the validating of the diagnosis algorithm includes:
inputting the plurality of degraded images into the diagnosis algorithm;
estimating, with the diagnosis algorithm, degrees of image degradation of the plurality of degraded images; and
comparing the estimated degrees of image degradation with the respective known degrees of image degradation.

(16) The information processing method of (15),
wherein the validating includes adjusting a parameter of the diagnosis algorithm according to the comparison.

(17) The information processing method of any one of (14) to (16),
wherein the plurality of degraded images is generated by augmenting images with degradations.

(18) The information processing method of any one of (13) to (17), wherein the determining of the operation mode includes:
determining, based on the determined degree of image degradation, whether a performance criterion of the information processing apparatus is fulfilled; and
determining the operation mode based on the determination whether the performance criterion is fulfilled.

(19) The information processing method of (18),
wherein the determining whether the performance criterion is fulfilled includes determining that the performance criterion is not fulfilled if the determined degree of image degradation exceeds a degradation threshold.

(20) The information processing method of (19),
wherein the performance criterion is based on a performance threshold for a performance indicator that indicates a performance of the information processing apparatus; and
wherein the degradation threshold is based on an intersection point of the performance indicator with the performance threshold.

(21) The information processing method of (20),
wherein the degradation threshold lies a predefined safety margin before the intersection point.

(22) The information processing method of (20) or (21),
wherein the performance indicator is based on a performance of the information processing apparatus measured during an operation of the information processing apparatus based on a plurality of degraded images with known degrees of image degradation input to the information processing apparatus.

(23) The information processing method of any one of (18) to (22),
wherein the method further comprises determining a safe mode as the operation mode when determining that the performance criterion is not fulfilled.

(24) The information processing method of any one of (13) to (23),
wherein the camera is included in the information processing apparatus.

(25) A computer program comprising program code causing a computer to perform the method according to anyone of (13) to (24), when being carried out on a computer.

(26) A non-transitory computer-readable recording medium that stores therein a computer program product, which, when executed by a processor, causes the method according to anyone of (13) to (24) to be performed.

1. An information processing apparatus, comprising circuitry configured to:
obtain image data captured with a camera;
determine a degree of image degradation based on the obtained image data, wherein the degree of image degradation indicates a degree of a physical reduction of an imaging capability of the camera; and
determine, based on the determined degree of image degradation, an operation mode of the information processing apparatus.

2. The information processing apparatus of claim 1,
wherein the determination of the degree of image degradation is based on a diagnosis algorithm validated with a plurality of degraded images with known degrees of image degradation.

3. The information processing apparatus of claim 2,
wherein the plurality of degraded images is generated by augmenting images with degradations.

4. The information processing apparatus of claim 1, wherein the determining of the operation mode includes:
determining, based on the determined degree of image degradation, whether a performance criterion of the information processing apparatus is fulfilled; and
determining the operation mode based on the determination whether the performance criterion is fulfilled.

5. The information processing apparatus of claim 4,
wherein the determining whether the performance criterion is fulfilled includes determining that the performance criterion is not fulfilled if the determined degree of image degradation exceeds a degradation threshold.

6. The information processing apparatus of claim 5,
wherein the performance criterion is based on a performance threshold for a performance indicator that indicates a performance of the information processing apparatus; and
wherein the degradation threshold is based on an intersection point of the performance indicator with the performance threshold.

7. The information processing apparatus of claim 6,
wherein the degradation threshold lies a predefined safety margin before the intersection point

8. The information processing apparatus of claim 6,
wherein the performance indicator is based on a performance of the information processing apparatus measured during an operation of the information processing apparatus based on a plurality of degraded images with known degrees of image degradation input to the information processing apparatus.

9. The information processing apparatus of claim 4,
wherein the circuitry is further configured to determine a safe mode as the operation mode when determining that the performance criterion is not fulfilled.

10. The information processing apparatus of claim 1,
wherein the camera is included in the information processing apparatus.

11. An information processing method, comprising:
obtaining image data captured with a camera;
determining a degree of image degradation based on the obtained image data, wherein the degree of image degradation indicates a degree of a physical reduction of an imaging capability of the camera; and
determining, based on the determined degree of image degradation, an operation mode of an information processing apparatus.

12. The information processing method of claim 11,
wherein the determination of the degree of image degradation is based on a diagnosis algorithm validated with a plurality of degraded images with known degrees of image degradation.

13. The information processing method of claim 12,
wherein the plurality of degraded images is generated by augmenting images with degradations.

14. The information processing method of claim 11, wherein the determining of the operation mode includes:
determining, based on the determined degree of image degradation, whether a performance criterion of the information processing apparatus is fulfilled; and
determining the operation mode based on the determination whether the performance criterion is fulfilled.

15. The information processing method of claim 14,
wherein the determining whether the performance criterion is fulfilled includes determining that the performance criterion is not fulfilled if the determined degree of image degradation exceeds a degradation threshold.

16. The information processing method of claim 15,
wherein the performance criterion is based on a performance threshold for a performance indicator that indicates a performance of the information processing apparatus; and
wherein the degradation threshold is based on an intersection point of the performance indicator with the performance threshold.

17. The information processing method of claim 16,
wherein the degradation threshold lies a predefined safety margin before the intersection point.

18. The information processing method of claim 16,
wherein the performance indicator is based on a performance of the information processing apparatus measured during an operation of the information processing apparatus based on a plurality of degraded images with known degrees of image degradation input to the information processing apparatus.

19. The information processing method of claim 14,
wherein the method further comprises determining a safe mode as the operation mode when determining that the performance criterion is not fulfilled.

20. The information processing method of claim 11,
wherein the camera is included in the information processing apparatus.
